(19) United States
(12) Patent Application Publication
(10) Pub. No.: US 2017/0263092 A1
(43) Pub. Date: Sep. 14, 2017

(54) SYSTEMS AND METHODS FOR THREAT MONITORING

(71) Applicant: Pinpoint, Inc., Austin, TX (US)

(72) Inventors: Jana Mechelle Rankin, Austin, TX (US); Aaron Harvey Shows, Austin, TX (US)

(21) Appl. No.: 15/456,379

(22) Filed: Mar. 10, 2017

Related U.S. Application Data
(60) Provisional application No. 62/306,539, filed on Mar. 10, 2016.

(51) Int. Cl. G08B 13/22; G08B 13/196; H04W 4/04

(52) U.S. Cl. CPC G08B 13/22; H04W 4/043; G08B 13/19656

(57) ABSTRACT

The present invention is directed to systems and processes for monitoring threats in a defined monitoring zone including a server, a radio frequency transmitter positioning system, a position database. The radio frequency transmitter positioning system includes one or more radio frequency receivers and a location module configured to provide location of radio frequency transmitters within the defined monitoring zone. The position database is configured to store radio frequency transmitter fingerprint data and associated person information. The system is configured to determine threat risk by comparison of the stored radio frequency transmitter fingerprint data with the fingerprints of active radio frequency transmitter fingerprint data within the defined monitoring zone.

### PRIORITY

The present invention claims priority to provisional application 62/306,539, which has a filing date of Mar. 10, 2016 and is incorporated by reference.

### BACKGROUND

### Field of the Invention

The present invention relates to threat monitoring, and more specifically to systems and methods of monitoring threats in a defined monitoring zone.

### Description of the Related Art

Bad actors in an interior environment such as a building present a difficult challenge for threat monitoring, threat assessment, and threat response relative to open air environments. Line of sight is often limited. Radio frequency propagation is also often limited, relative to unimpeded omnidirectional propagation, due to walls and other internal structures. Building occupants' exit paths are often limited, thus occupants' ability to exit may be impeded. Limited radio frequency transmission can limit occupants' ability contact people outside the building. Furthermore, emergency responders' and law enforcement's ability to monitor a bad actors and direct victims is limited due to inability to actively view the situation and communicate. Those factors work to a bad actor's advantage. For the above reasons, it would therefore be advantageous to have systems and methods to monitor potential threats in interior environments.

### SUMMARY

The present invention is directed to systems and processes for monitoring threats in a defined monitoring zone including a server, a radio frequency transmitter positioning system, a position database. The radio frequency transmitter positioning system includes one or more radio frequency receivers and a location module configured to provide location of radio frequency transmitters within the defined monitoring zone. The position database is configured to store radio frequency transmitter fingerprint data and associated person information. The system is configured to determine threat risk by comparison of the stored radio frequency transmitter fingerprint data with the fingerprints of active radio frequency transmitter fingerprint data within the defined monitoring zone.

These and other features, aspects, and advantages of the invention will become better understood with reference to the following description, and accompanying drawings.

### BRIEF DESCRIPTION OF THE DRAWINGS

FIGS. 1A and 1B depict diagrams of embodiments of systems according to the current invention as they may exist in operation;

FIG. 2 depict a diagram of an embodiment of a system according to the current invention as it may exist in operation;

FIG. 3 depicts a flowchart of the major steps of an embodiment of a process according to the current invention;

FIG. 4A depicts a representative map of a defined monitoring zone;

FIG. 4B depicts a representative map of a defined monitoring zone with a representative person overlay;

FIG. 4C depicts a representative map of a defined monitoring zone with a representative person overlay and threat actor overlay;

FIG. 4D depicts a representative map of a defined monitoring zone with a representative person overlay, threat actor overlay, and directional signals; and

FIG. 5 depicts a representative threat communication interface of the system.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

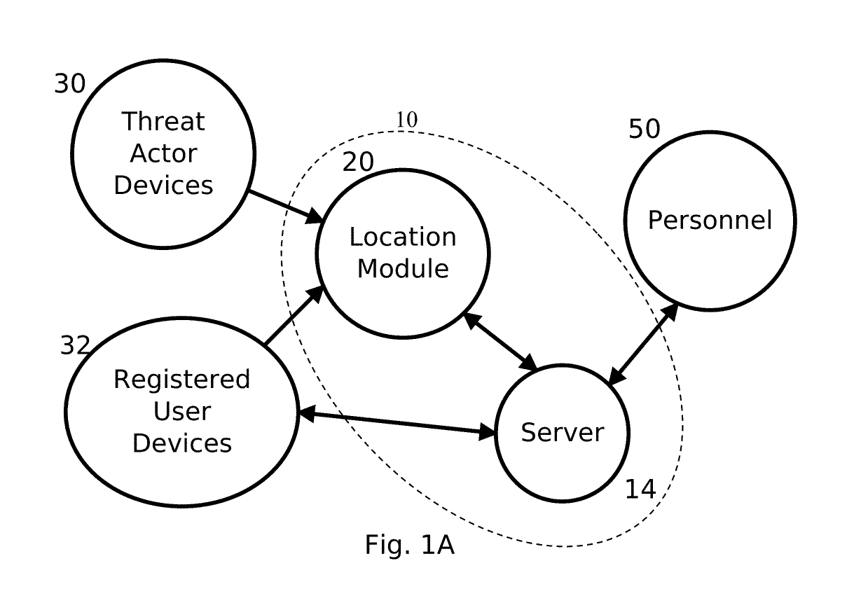

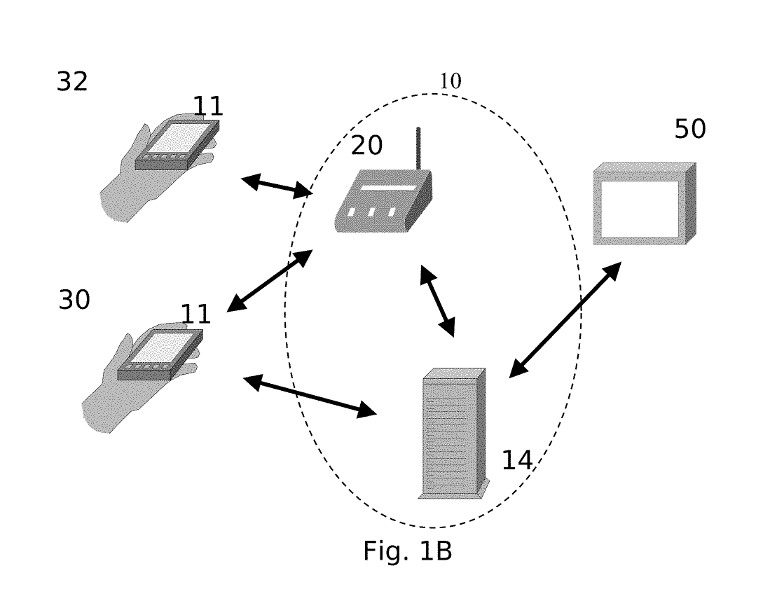

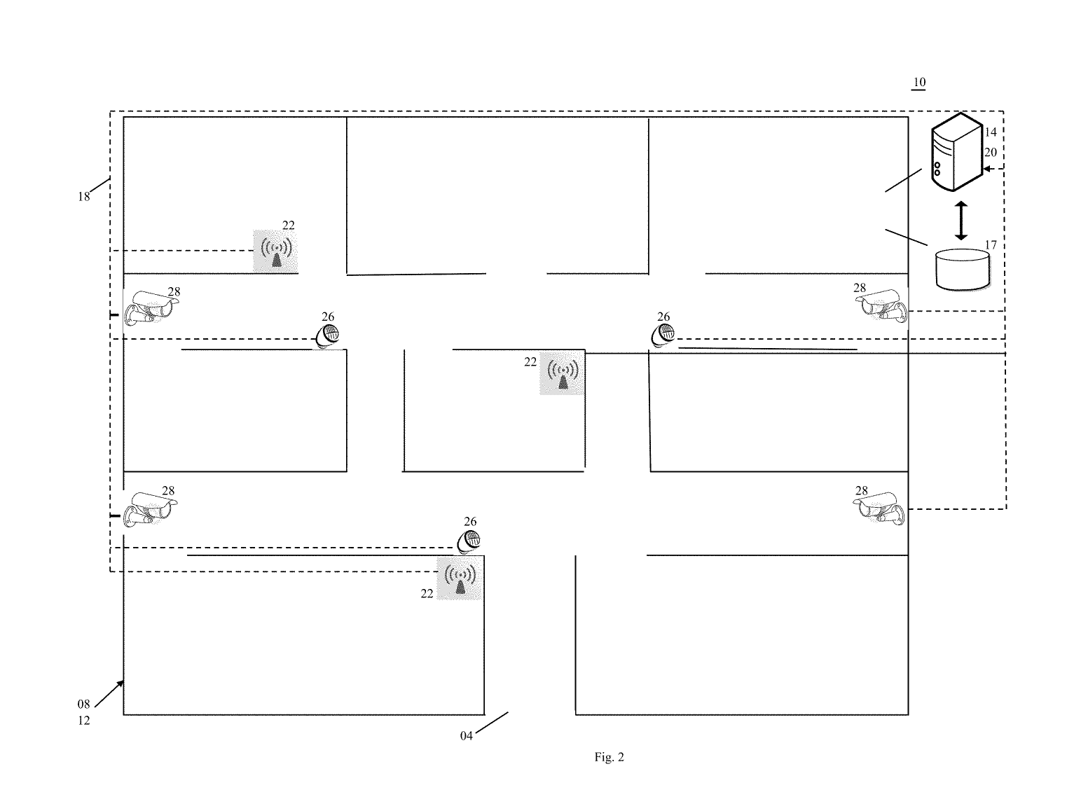

Exemplary embodiments of the current invention are directed to systems and processes for threat monitoring and communication by radio frequency (RF) transmitter monitoring. The present invention includes embodiments for identification, position monitoring, and communication with RF transmitters, such as those in mobile computers 11, associated with one or more persons, in a defined monitoring zone 12. FIGS. 1A, 1B, and 2 illustrate embodiments of systems 10 as they may exist in operation. Illustrated are a server 14 and positioning system 20 within a defined monitoring zone 12.

Exemplary systems are deployed where the defined monitoring zone 12 is a closed interior environment 08, commonly a building 08. A building 08 is a structure with a roof and walls standing more or less permanently in one place. Buildings 08 may be built in a variety of shapes, dimensions, and functions, such as homes, schools, or offices. The building 08 is commonly enclosed by walls and subdivided into rooms, and having a limited number of exits 04. Building materials or later additions to the roof or walls vary and often impede weak radio frequency (RF) signals such as GPS. As a result, the mobile computers 11 of interior occupants may not receive GPS signals. Alternatively, the time of flight of the GPS signal may be altered, with the mobile computers 11 receiving an attenuated, scattered, reflected, or multipath GPS signals. In turn, the GPS signal is not sufficiently reliable for relative position tracking in the defined monitoring zone 08.

Exemplary embodiments of systems 10 track the locations of RF transmitters in the defined monitoring zone 12. One such RF transmitter is one within a mobile computer 11, such as a smartphone. A smartphone can have one or more RF transmitters, such as Bluetooth, WiFi, and cellular radios. A mobile computer 11, server 14, smartphone, tablet as used in this specification is a computer. A computer generally refers to a system which includes a central processing unit (CPU), memory, a screen, a network interface, and input/output (I/O) components connected by way of a data bus. The I/O components may include for example, a mouse, keyboard, buttons, or a touchscreen. The network interface enables data communications with the computer network. A server is a computer containing various server software programs and preferably contains application server software. A mobile computer is a computer such as a smartphone or tablet PC with smaller dimensions, such as iPhone, iPod Touch, iPad, Blackberry, or Android based device. A mobile computer also includes a “geo tag,” a stripped down computer with a process with a single purpose to transmit RF for position monitoring. Those skilled in the art will appreciate that computer may take a variety of configurations, including personal computers, hand-held devices, multi-processor systems, microprocessor-based electronics, network PCs, minicomputers, mainframe computers, and the like. Additionally, a computer may be part of a distributed computer environment where tasks are performed by local and remote processing devices that are linked. Although shown as separate devices, one skilled in the art can understand that the structure of and functionality associated with the aforementioned elements can be optionally partially or completely incorporated within one or the other, such as within one or more processors. As noted above, the processes of this invention, or subsets thereof, may exist in on one or more computers such as a client/server approach.

The process, or subsets thereof, may exist in a machine-readable medium which causes a computer to carry out instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention or aspects thereof may be downloaded as a computer program or “app” which may be transferred from a remote computer to a requesting computer by way of data signals embodied in a carrier wave or other propagation medium via a communication link.

In certain embodiments, the computers communicate over a network 18, which may include one or more local area networks (LANs), wide area networks (WANs), all or a portion of the Internet, and/or any other communication system or systems at one or more locations. Network 18 may be all or a portion of an enterprise or secured network, while in another instance at least a portion of the network 18 may represent a connection to the Internet. Further, all or a portion of network may comprise either a wireline or wireless link. In other words, network 18 encompasses any internal or external network, networks, sub-network, or combination thereof operable to facilitate communications between various computing components inside and outside the illustrated environment. The network 18 may communicate, for example, Internet Protocol (IP) packets, Frame Relay frames, Asynchronous Transfer Mode (ATM) cells, voice, video, data, and other suitable information between network addresses. The exemplary mobile computers 11 for monitoring within the defined monitoring zone 08 have wireless local area network radios, such as the IEEE 802.11 standards, or bluetooth radios, such as the IEEE 802.15.1 standard.

The illustrated embodiment includes RF transmitter positioning system, such as an indoor positioning system 20. The indoor positioning system 20 is one or more components operable to determine position objects or people inside the building 08 using radio waves, magnetic fields, acoustic signals, or other sensory information collected by mobile devices. An exemplary indoor positioning system 20 is one which employs radio waves, more specifically cellular, WiFi, or Bluetooth radio waves. Corresponding receivers are disposed within the defined monitored zone 12. One such configuration includes a plurality of spaced apart WiFi access points 22, each at a known fixed location. In certain embodiments, the illustrated indoor positioning system 20 includes one or more WiFi access points 22 and a module for processing received RF data and characteristics on the server 14. The module on the server 14 employs time of flight/time of arrival, time difference of arrival, round trip delay, received signal strength indication, and triangulation, and other approaches to determine the position of a given mobile computer 11.

Time of arrival and time of flight is known in the art and not discussed in detail here. Time of arrival/time of flight is the amount of time a signal takes to propagate from transmitter to receiver. Using the signal propagation rate, the travel time of a signal is used to calculate distance. Multiple measurements can be combined with triangulation to find and improve location.

Time difference of arrival is known in the art and not discussed in detail here. Time difference of arrival includes an antenna array. The time difference of arrival is typically determined by measuring the time difference of arrival between multiple antennas in the sensor array. In other receivers, it is determined by an array of highly directional sensors, the angle can be determined by which sensor received the signal. Angle of arrival is usually used with triangulation and a known base line to find the location relative to two anchor transmitters.

Received signal strength indication is known in the art and not discussed in detail here. Received signal strength indication is a measurement of the power level received by a sensor. Using the inverse-square law of RF propagation, distance is approximated based on the relationship between transmitted and received signal strength where the transmission strength is a relatively constant based on the equipment being used.

Each of the above approaches has a certain range of error. For example, Wi-Fi signal strength measurements can be noisy, so certain embodiment may use statistics to filter out the inaccurate input data. The inside of buildings 08 is not free space, so accuracy is impacted by reflection and absorption from walls. Objects such as doors, furniture, and people can pose an accuracy problem, as they can affect the signal strength in dynamic, unpredictable ways. Certain embodiments may employ algorithms and equipment for improved accuracy. Certain embodiments employ enhanced Wi-Fi infrastructure improved accuracy. Certain embodiments employ enhanced synchronization improved accuracy.

A representative suitable indoor positioning system 20 is the Cisco's Connected Mobile Experiences system (CMX). Certain configurations of the CMX indoor positioning system 20 employ one or more access points 22, an application/module on the mobile device 11, and server 20 modules for mobile device 11 location processing.

Additional disclosure of indoor positioning systems is include in U.S. patent application Ser. No. 11/682,649, entitled “Determining the time of arrival of a wireless signal”, which is hereby incorporated by reference. Additional disclosure of indoor positioning systems is include in U.S. patent application Ser. No. 10/803,367, entitled “Radiolocation in a wireless network using time difference of arrival”, which is hereby incorporated by reference. Additional disclosure of indoor positioning systems is include in U.S. patent application Ser. No. 12/405,383, entitled “Clock synchronization”, which is hereby incorporated by reference. Additional disclosure of indoor positioning systems is include in U.S. patent application Ser. No. 11/619,939, entitled “Locally adjusted radio frequency coverage maps in wireless networks”, which is hereby incorporated by reference. Additional disclosure of indoor positioning systems is include in U.S. patent application Ser. No. 11/543,747, entitled “Radio frequency coverage map generation in wireless networks”, which is hereby incorporated by reference. Additional disclosure of indoor positioning systems is include in U.S. patent application Ser. No. 11/542,720, entitled “Location inspector in wireless networks”, which is hereby incorporated by reference. Additional disclosure of indoor positioning systems is include in U.S. patent application Ser. No. 13/453,642, entitled “Generating Accurate Dynamic Heat Maps”, which is hereby incorporated by reference. Additional disclosure of indoor positioning systems is include in U.S. patent application Ser. No. 12/875,680, entitled “Location Estimation for Wireless Devices”, which is hereby incorporated by reference.

In certain configurations, the system 10 includes specialized storage in the form of a position database 17 configured to store location data of mobile computers 11 within the building 08. In exemplary configuration, position information for mobile computers 11, mobile computer 11 identifying information, associated user information, and defined monitoring zone 08 12 are received for storage. For example, an X, Y, Z coordinate may be received for storage in the position database 17. One skilled in the art would appreciated that the data may reside in one or more databases, tables, or computers. Representative suitable database systems include text, SQL, noSQL, or other repositories known in the art.

Certain embodiments of the system 10 include one or more cameras 28 for placement in the building 08, at known positions and orientations. An exemplary camera 28 is operable to provide electronic image acquisition and transmission to the server 14 over the network 18 for storage in the position database 17 or other processing. The system optionally provides a facial recognition module for processing of camera 28 input, identification of individuals, association with the position of the camera 28, and/or association with a mobile device.

Certain embodiments of the system 10 include one or more sound sensors 26 for placement in the building 08. The exemplary sound sensors 26 is operable to provide electronic audio acquisition and transmission to the server 14 over the network 18 for storage in the position database 17 or other processing. A suitable sound sensor 26 can include a microphone which captures the broad audio spectrum. Other suitable sound sensors 26 are tuned for specific function such as gunshots or crowd noise, by band, amplitude filtering, and/or other sound characteristics. In certain configurations, the sound sensors 26 are integral with the cameras 28.

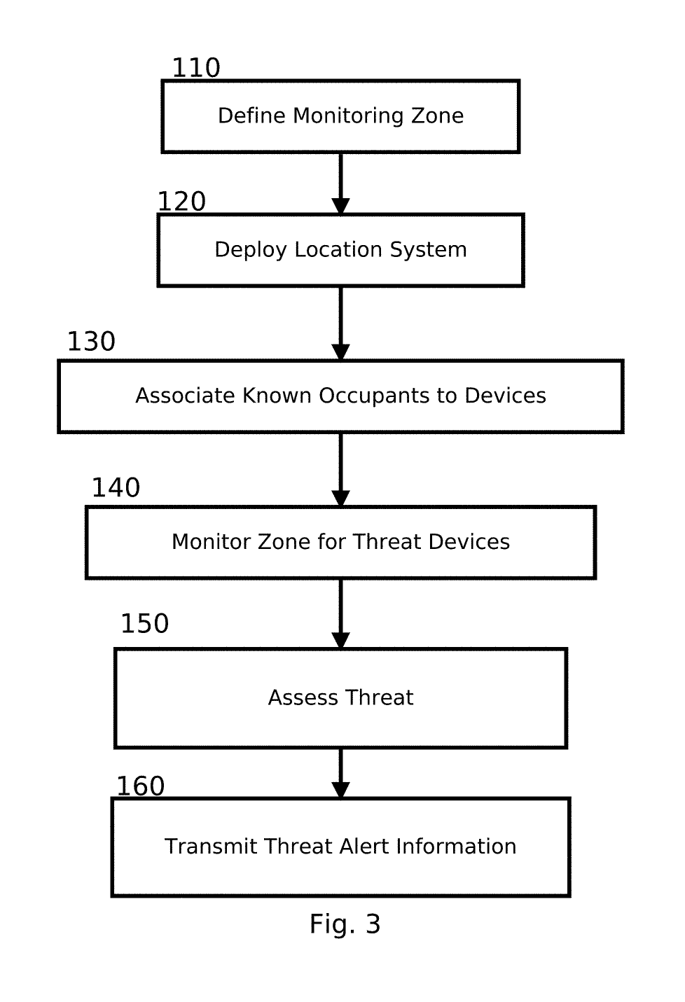

Referring to FIG. 3, an exemplary process for identification, position monitoring, and communication with mobile computers 11, associated with one or more persons, in a defined monitoring zone 12 is disclosed. At step 110, a monitor zone is defined. At step 120, a position system is deployed to the defined monitoring zone. At step 130, RF transmitters expected to be within the defined monitoring zone are associated with persons. At step 140, the monitoring zone is monitored for threat devices. At step 150, the transmissions within the defined monitoring zone are monitored for threat risk assessment. At step 160, conditional messages are broadcast in response to the threat assessment. More consideration to each of the steps will be given below.

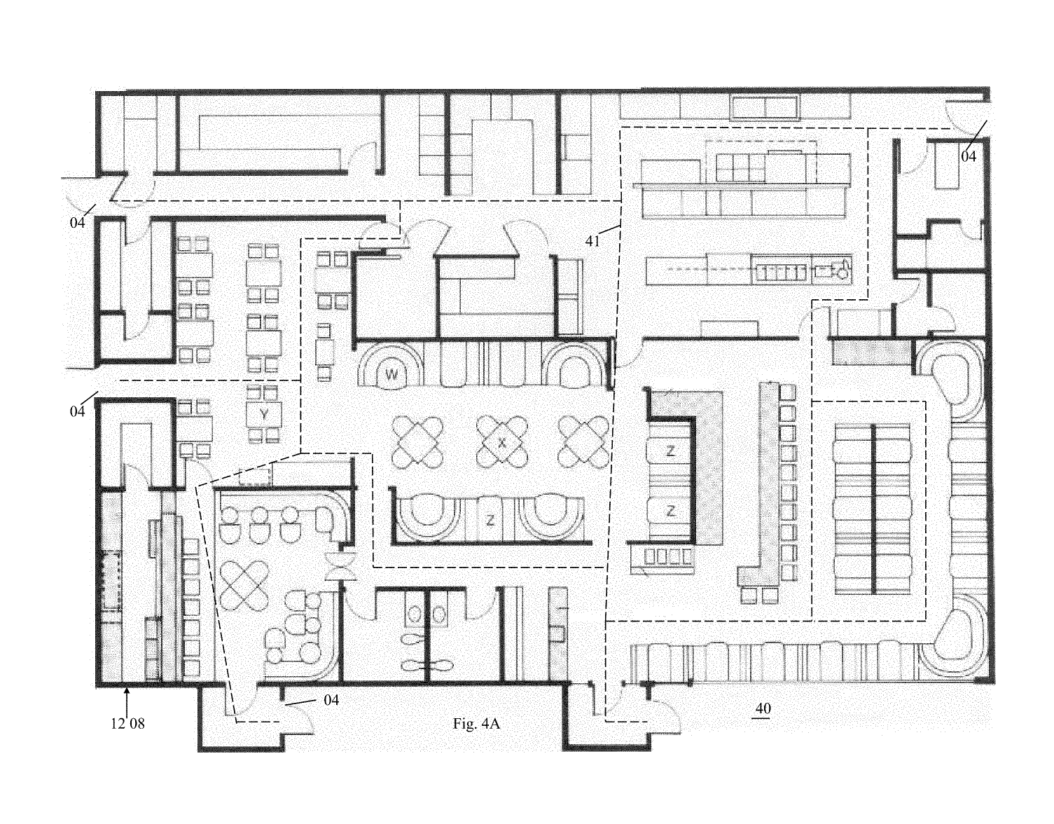

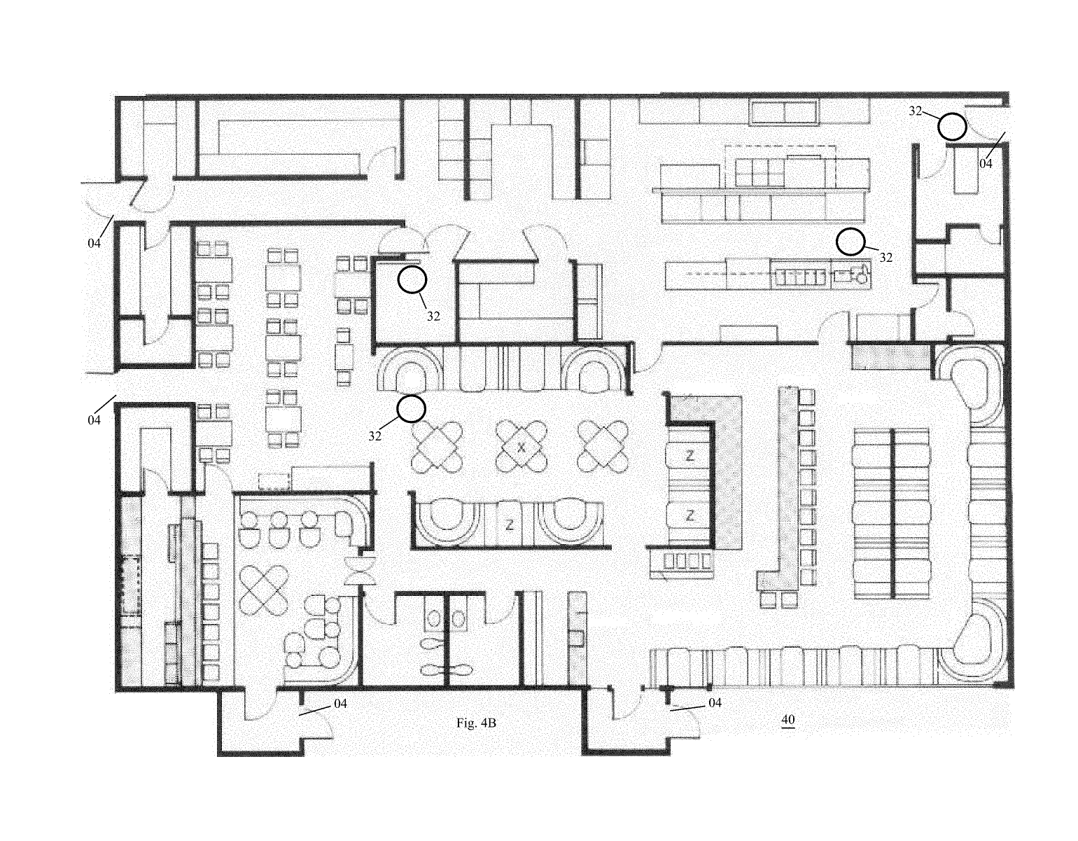

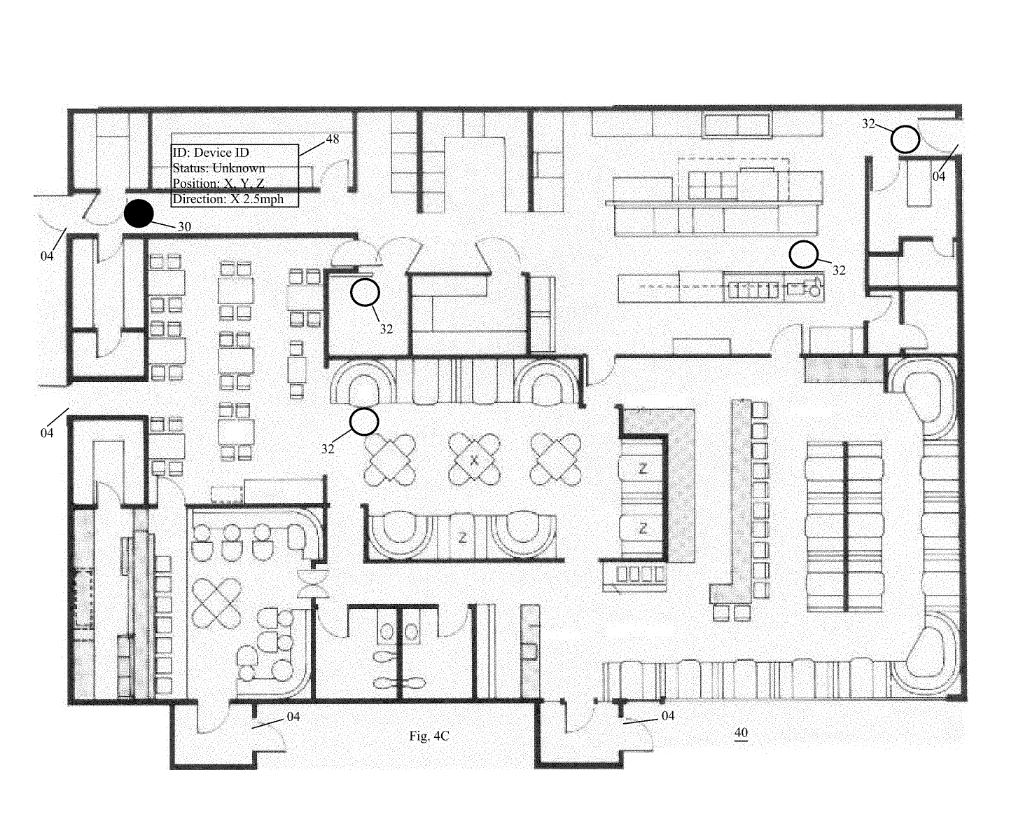

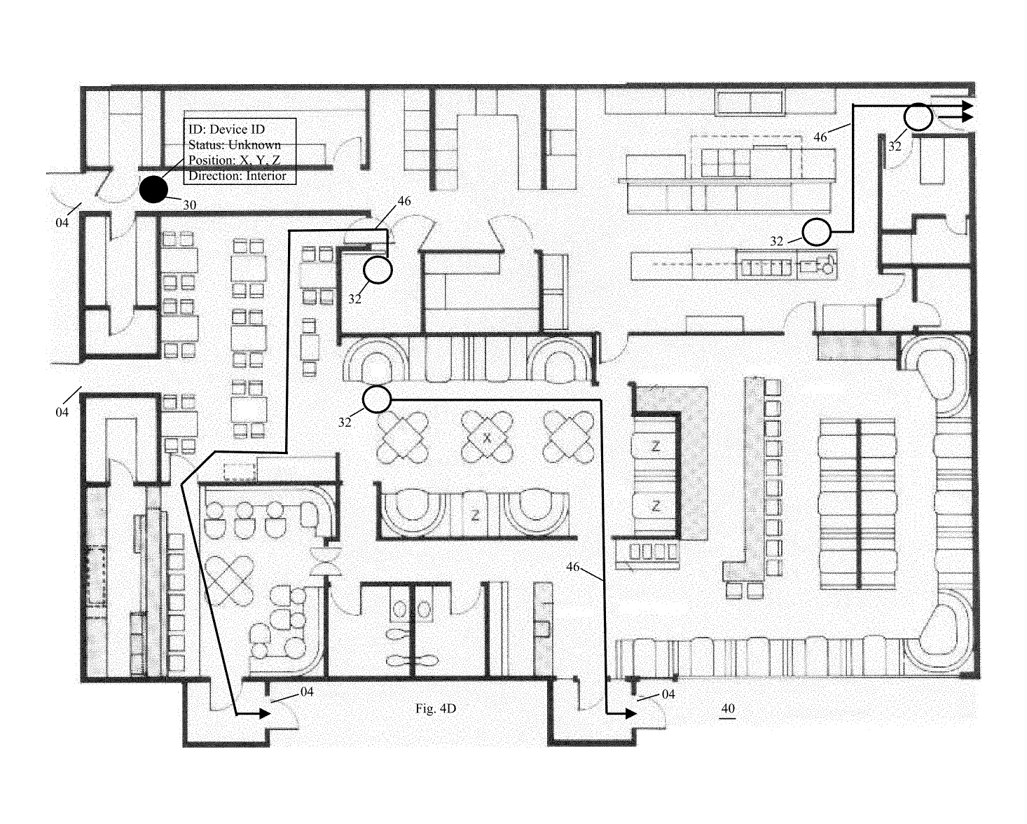

At step 110, the monitoring zone 12 is defined. Commonly, this will be one or more buildings 08, such a campus or office, or a part of the building 08. A map 40 for the monitoring zone 12 is received or generated. FIG. 4A illustrates a representative map 40 of a defined monitoring zone 12 for display in an interface 34. In certain configurations, paths 41 through the environment are determined and stored in the position database 17. In certain configurations, exit 04 positions are determined and stored in the position database 17. Indoor path planning is known in the art and not disclosed in detail here. Many path planning algorithms have been developed in the fields of computer science. Suitable path planning algorithms generates efficient collision-free paths for providing navigational assistance from a user's current position to an exit 04. Certain algorithms employ 2D drawings or scans, 3D drawings or scans, or building layouts as input, possibly with few attached attributes for obstacles, in path planning.

At step 120, a positioning system 20 such as an indoor positioning system 20 is deployed to the defined monitoring zone 12. In certain configurations, spaced apart wifi access points 22, or other receiver types, are deployed throughout the monitoring zone 12. In certain configurations, the wifi access points 22 are deployed with density such that mobile device 11 signals can be received at a threshold number of wifi access points 22 for improved position accuracy. Wifi access point 22 communication with the position analysis module on the server 14 is established over the network 18. The position of each wifi access point 22 is stored in the position database 17. Similarly configured receivers may be setup for cellular, bluetooth, or other protocols.

In some processes, cameras 28 and sound sensors 26 are deployed at known positions within the monitoring zone 12. The position and other information for each of the cameras 28 and sound sensors 26 is stored in the position database 17. Communication over the network 18 is established for the cameras 28 and sound sensors 26.

At step 130, known devices within the monitoring zone are associated with persons. In expected operation, there will be a set of regular occupants entering the defined monitoring zone 12. The occupants normally carry a mobile computer 11 on their person. The system 10 receives and stores the association of the person to their mobile computer 11. The RF transmitter of the person's mobile computer 11 is fingerprinted, wherein transmission data and characteristics of the person's mobile computer 11 are acquired and stored for processing and later comparison. In exemplary process, a unique identifier of the mobile computer 11 is acquired. Commonly, each radio within a mobile computer 11 has a media access control address (MAC address) or other identifier, which is a unique identifier assigned to the radio of the mobile computer 11 for communications. MAC addresses are often used and can be acquired as a network address for network protocols. In certain processes, one or more transmissions are captured and processed for fingerprinting.

In order to associate the mobile computer 11 with a person, various approaches may be used. In certain process, the person may download an application to their mobile computer 11 or the system 10 may present a portal such as a webpage to the person. The downloaded application can accept input as to the identity of the person. In other processes, as part of the process of registration at the campus or office, identity may be established as part of the employment or registration process. The unique identifier and identity are stored in the position database 17. Other identifying information of the person such as images, facial or otherwise, or voice may be received and stored. In addition to identity, each person may be assigned to a group. For example, in a campus environment, people might be assigned to student, parent, faculty, or security groups. In an office environment, people might be assigned to employee or security groups.

At step 140, the monitoring zone 12 is monitored for threshold threat risk devices. The indoor position system 20 is activated. The indoor position system 20 is activated and identifies the mobile computers 11 within the defined monitoring zone 12. The position of each mobile computer 11 within the monitoring zone 12 is determined as previously disclosed, with the presence and location for each mobile device 11 being determined. The positions of each mobile computer 11 within the monitoring zone 12 are visually overlaid on the map 40 of the building 08 resulting in a composite map 42. FIG. 4B illustrates an overlay 42 of the mobile computers 11 within the monitoring zone 12. Exemplary composite maps 42 include visual indicia of the position of each mobile computer 11. For example, the composite map 42 may include a registered device indicator 44 and an unknown or threat risk actor indicator 45. Optionally, the indicia further indicates grouping of the person associated with the mobile computer 11. For example, the indicia may be color coded with the indicia colors corresponding to the group of the associated person. The system 10 periodically compares the fingerprint of the mobile computers 11 within the monitoring zone 12 with those of the registered devices 32 in the position database 17 for threat risk assessment. One threat risk assessment factor is mobile computers 11 devices 30 that are not known, which may be determined by unknown fingerprint information, such as an unknown radio identifier. They can then be assigned an unknown mobile computer 11 status. Another threat risk assessment factor is mobile computers 11 devices 30 that are specifically blacklisted, which may be determined by having known fingerprint information, such as a known radio identifier, which has been designated as a high risk. Prior contact, court records, or other available databases can server as blacklist sources.

FIG. 4B illustrates a composite map 42 of the mobile computers 11 within the monitoring zone 12, while FIG. 4C illustrates a composite map with the known mobile computers' 11 position overlay 42 and with an unknown mobile computer 11 position overlay 42.

At step 150, the threat associated with the unknown device 32 presence is assessed. Various configurations can employ different threat assessment procedure. In certain configurations, the threat level is set by mere presence of an unknown device in the building 08. In certain configurations, the threat level is assessed by personnel 50 in the building 08. For example, the person holding the unknown device 32 may display threatening or potentially threatening behavior. In such a situation, another building occupant may input a threat assessment in the system for current or future use. In other configurations, the unknown device's identifier may be compared to one or more lists of device identifiers for association with an individual and, in turn, a threat level.

A threshold threat condition may be triggered. In such a condition, the fingerprint information, such as the radio identifier, associated with the person is flagged. The position of that threat actor 45 may be further monitored. Additionally, projections of the threat actor 45 may be calculated, based on the threat actor's 45 speed and direction of travel, the travel paths 41, intent, and other information.

At step 160, conditional messages 48 are broadcast in response to a threshold threat condition. The message 48 format and content can vary according to the group. In various configurations, the messages 48 are sent by SMS/MMS, email, in-app messaging, or other available communication channels. In certain processes, the system 10 sends messages to predetermined groups. FIG. 4C illustrate an example message for transmission in a threat situation. For example, predetermined groups may include internal groups. In a campus environment, predetermined groups might include personnel 50 in the security group, such as law enforcement. The system 10 retrieves the contact information for the security group. The system 10 transmits a broadcast message(s) to the group. For example, the content of the message to that group may be the status, that is to say a threat situation and the current location of the unknown device.

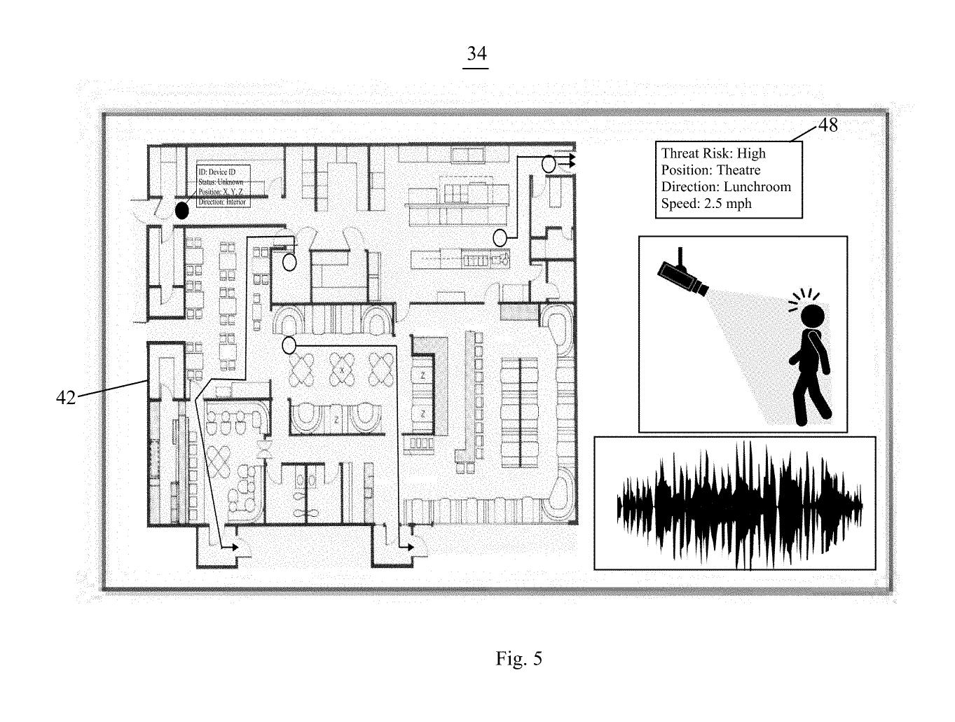

FIG. 5 illustrates a representative interface 34 having a composite map 42, audio output for receipt and output of sound sensor 26 data, and video output for receipt and display of camera 28 data. The system 10 may launch an interface 34 for the group for real-time or near real-time access the position of the threat actor 45, real-time or near real-time access to the cameras 28 and sound sensors 26, real-time or near real-time access the position of the known mobile computers 11. The interface 34 may provide access to the audio sensor 26 data or the camera 28 data proximate the instant user, proximate the threat actor 45, proximate the exit path 46, or other selected locations.

FIG. 4D illustrates other example broadcast message content and format in the form of direction information. For example, student or employee group's may receive messages with suggested directions to an exit 04. The system 10 retrieves the position information for the threat actor 45. The system 10 retrieves the position information for the subject user 44. Based on that position and the position information for the individuals, the system 10 determine an exit path 46 for the individual. An optimum exit route is one in which the individual avoids or minimizes probable contact with the current or projected position of the threat actor 45 en route to the exit 04. FIG. 4D illustrates message content in the format of a map overlay for individuals with an exit route 46 for expedient escape.

Insofar as the description above, and the accompanying drawing disclose any additional subject matter that is not within the scope of the single claim below, the inventions are not dedicated to the public and the right to file one or more applications to claim such additional inventions is reserved.

What is claimed is:

1. A system for monitoring threats in a defined monitoring zone comprising:
a server and radio frequency transmitter positioning system;
said server including a processor, memory, and a position database;
said radio frequency transmitter positioning system including one or more radio frequency receivers and a location module configured to provide location of radio frequency transmitters within said defined monitoring zone;
said position database configured to store radio frequency transmitter fingerprint data and associated person information; and
said system configured to determine threat risk by comparison of said stored radio frequency transmitter fingerprint data with the fingerprints of active radio frequency transmitter fingerprint data within said defined monitoring zone.

2. The system of claim 1, wherein said radio frequency receiver is selected from the following: wife, bluetooth, cellular.

3. The system of claim 1, where said fingerprint includes a MAC address.

4. The system of claim 1, where a threshold threat condition is triggered in response to unknown radio frequency transmitter.

5. The system of claim 1, where a threshold threat condition is triggered in response to blacklisted radio frequency transmitter.

6. The system of claim 1, further comprising a camera in communication with said server.

7. The system of claim 1, further comprising a sound sensor in communication with said server.

8. The system of claim 1, wherein said server is configured to transmit an interface upon a threshold threat risk.

9. The system of claim 8, wherein said interface includes a composite map, said composite map including position indicators for radio frequency transmitters within the defined monitored zone.

10. The system of claim 8, wherein said interface includes an exit path, said exit path being from a user's current position to an exit and minimizing probable contact with the current or projected position of a threat actor.

11. A process for monitoring threats in a defined monitoring zone comprising:
providing a server, said server including a processor and memory;
providing a radio frequency transmitter positioning system, said radio frequency transmitter positioning system including one or more radio frequency receivers and a location module configured to provide location of radio frequency transmitters within said defined monitoring zone;
providing a position database, said position database configured to store radio frequency transmitter fingerprint data and associated person information;
receiving and storing fingerprint data of radio frequency transmitters expected to be within said defined monitored zone; and
said system periodically monitoring for active radio frequency transmissions within said defined monitored zone, processing the active radio frequency transmissions to determine the fingerprint data, comparing said active radio frequency transmission fingerprint data with said stored radio frequency transmitter fingerprint data, generating a threat risk based on said comparison.

12. The process of claim 11, further comprising receiving map data for said defined monitoring zone, including paths and exits within said defined monitoring zone.

13. The process of claim 11, wherein said radio frequency receiver is selected from the following: wife, bluetooth, cellular.

14. The process of claim 11, where said fingerprint data includes a MAC address.

15. The process of claim 11, where a threshold threat condition is triggered in response to unknown radio frequency transmitter.

16. process of claim 11, further providing a camera in communication with said server.

17. process of claim 11, further providing a sound sensor in communication with said server.

18. The process of claim 11, wherein said server transmits an interface upon a threshold threat risk, said interface includes a composite map, said composite map including position indicators for radio frequency transmitters within the defined monitored zone.

19. The process of claim 18, said interface includes audio sensor data or camera data proximate the instant user's location.

20. The process of claim 11, wherein said server transmits an interface upon a threshold threat risk, wherein said interface includes an exit path, said exit path being from a user's current position to an exit and minimizing probable contact with the current or projected position of a threat actor.
